(19) United States
(12) Patent Application Publication
(10) Pub. No.: US 2019/0216118 A1
(43) Pub. Date: Jul. 18, 2019

(54) LIQUID SWEETENER COMPOSITIONS

(71) Applicant: Merisant US, Inc., Chicago, IL (US)

(72) Inventor: David Joseph Sitko, Chicago, IL (US)

(21) Appl. No.: 16/251,614

(22) Filed: Jan. 18, 2019

Related U.S. Application Data
(62) Division of application No. 62/618,889, filed on Jan. 18, 2018.

(51) Int. Cl. A23L 27/30; A23L 29/30; A23L 21/25

(52) U.S. Cl. CPC A23L 27/36; A23V 2002/00; A23L 21/25; A23L 29/30

(57) ABSTRACT

The disclosure relates generally to sweetener compositions. The disclosure relates more particularly to aqueous sweetener compositions of high intensity sweeteners, such as specific combinations of rebaudioside A, rebaudioside D, and rebaudioside M; and methods of using such aqueous sweetener compositions.

### CROSS REFERENCE TO RELATED APPLICATIONS

This application claims the benefit of priority of U.S. Provisional Patent Application No. 62/618,889, filed Jan. 18, 2018, which is hereby incorporated by reference in its entirety.

### BACKGROUND OF THE INVENTION

### Field of the Invention

The disclosure relates generally to sweetener compositions. The disclosure relates more particularly to aqueous sweetener compositions of high intensity sweeteners, such as specific combinations of rebaudioside A, rebaudioside D, and rebaudioside M; and methods of using such aqueous sweetener compositions.

### Description of Related Art

The species Stevia rebaudiana (“Stevia”) has been the subject of considerable research and development efforts directed at the purification of certain naturally occurring sweet glycosides of Stevia that have potential as non-caloric sweeteners. Sweet glycosides that may be extracted from Stevia include all reported rebaudiosides (i.e., rebaudiosides A, B, C, D, E, F, M, N and O), as well as stevioside, and the dulcosides, e.g., dulcosides A and B.

Non-caloric or low-caloric sweeteners can be delivered to consumers through solid or liquid applications. For example, packets of dry sweeteners are commonly used for sweetening coffee or other consumable products by sprinkling the contents of the packages over such products. Non caloric or low caloric sweeteners can also be delivered in liquid form. For example, reduced calorie forms of honey and agave are desirable and can be delivered to consumers in conventional glass or plastic containers. Liquid sweeteners also have utility as a means of delivering sweetness to other food and beverage products.

Thus, there is an interest in improving liquid carbohydrate formulations (such as natural and other syrups) so that they have fewer calories or so that a reduced amount of the sweetener may be used without sacrificing taste. The caloric content of liquid carbohydrate formulations may be reduced by decreasing the solids content and/or the carbohydrate content of the formulation, which in turn reduces the caloric content. When the solids are removed, gums have been added to create texture, and natural or artificial flavors have been added to create or enhance the flavor. Formulations made in this manner have many undesirable attributes. For example, these gum based low calorie formulations have an unnatural mouth feel (e.g., they are slimy, gummy, or thin), minimal aroma, and do not have the expected taste. In turn, high intensity sweeteners have been used to adjust the sweetness of the liquid formulations; however, the resulting products lack certain desirable characteristics. For example, rebaudiosides, such as rebaudiosides A, B, C, D, E, F, M, N and O, stevioside, and dulcosides A and B sometimes cannot be dissolved in a liquid formulation, and when these high intensity sweeteners are used to prepare modified formulations, the resulting modified formulations become cloudy or have visible precipitate (i.e., sedimentation) after prolonged storage, a characteristic which is not expected by or appealing to consumers. Sweetener products typically are shipped to food service providers where they are used for a prolonged period of time, or they are located on grocery or mass merchandiser shelves where they are stored for a prolonged period of time. Such products are typically expected to have shelf life of at least 1 to 2 years. The ease of transportation and visual stability of such products is thus crucial.

### SUMMARY OF THE INVENTION

Steviol glycosides are desired for use in sugar-replacing or sugar-reducing sweetener applications for their combination of sweetness potency (about 200-400 times sweeter than sugar) and flavor profiles. Utilization of many steviol glycosides and combinations thereof in liquid applications is severely hampered by their poor solubility. Tabletop sweeteners have traditionally relied on using steviol glycosides at the maximum concentration level attainable in aqueous solution. This also requires that the tabletop sweetener formulation is diluted (i.e., has a significant amount of additional water) to properly dissolve the steviol glycoside.

The inventors have found improved sweetener compositions, particularly aqueous sweetener compositions comprising a specific combination of rebaudiosides, e.g., rebaudioside A, rebaudioside D, and rebaudioside M, that addresses these issues. Thus, one aspect of the disclosure provides an aqueous sweetener composition including:
about 20% to about 60% by weight of rebaudioside composition, wherein the rebaudioside composition comprises: rebaudioside A, rebaudioside D, and rebaudioside M, wherein the ratio of rebaudioside A to the sum of rebaudioside D and rebaudioside M is about 1:1 to about 3:1, and wherein the ratio of rebaudioside M to rebaudioside D is about 1:2.3 to about 2.3:1;
and water.

Another aspect of the disclosure provides a syrup composition including about 2-10% by weight of the aqueous sweetener composition of the disclosure, and about 90-98% by weight of one or more syrups.

In a further aspect, the disclosure provides methods for preparing the syrup compositions of the disclosure. For example, in one embodiment, such methods include:
providing an aqueous sweetener composition of the disclosure having a temperature of about 50° C. to about 95° C., and
adding the aqueous sweetener composition to a syrup to produce the desired syrup composition.

### BRIEF DESCRIPTION OF THE DRAWINGS

The accompanying drawings are included to provide a further understanding of the compositions and methods of the disclosure, and are incorporated in and constitute a part of this specification. The drawings illustrate one or more embodiment(s) of the disclosure, and together with the description, serve to explain the principles of the disclosure.

FIG. 1 illustrates the physical appearance of the samples that are labeled as “A,” “B,” and “C” in Tables 1 and 2.

### DETAILED DESCRIPTION OF THE INVENTION

Before the disclosed materials and methods are described, it is to be understood that the aspects described herein are not limited to specific embodiments, or configurations, and as such can, of course, vary. It is also to be understood that the terminology used herein is for the purpose of describing particular aspects only and, unless specifically defined herein, is not intended to be limiting.

In view of the present disclosure, the active materials and methods described herein can be configured by the person of ordinary skill in the art to meet the desired need. In general, the disclosed materials and methods provide improvements in aqueous sweetener compositions, particularly aqueous sweetener compositions comprising a specific combination of rebaudiosides, e.g., rebaudioside A, rebaudioside D, and rebaudioside M, that addresses these issues. For example, in certain aspects, the sweetener compositions of the disclosure have improved appearance, taste, and improved shelf-life. The sweetener compositions have clear and homogeneous appearance, even after several months. For example, the sweetener compositions allow for rebaudioside A, rebaudioside D, and rebaudioside M to remain in an aqueous solution for a long period of time without becoming cloudy (e.g., without the rebaudiosides crystallizing out of the solution) making the sweetener compositions more appealing to consumers. In addition, when used in other products (such as syrups), the rebaudiosides component of the sweetener composition provides additional sweetness to these products, making them further appealing to the consumers due to the improved taste or lower calorie consumption (e.g., by consumers using less of the product yet maintaining the desired sweetness).

As used herein, the term “clear” means substantially free of undissolved steviol glycosides, in particular rebaudiosides, upon visual inspection by a person of skill in the art. For example, the aqueous sweetener compositions of the disclosure are homogenous showing a substantially complete dissolution of the rebaudiosides in water. In certain embodiments, the term “substantially complete dissolution” means no solid material is apparent upon visual inspection, such as no cloudiness or larger particles in the solution or no sedimentation. In addition, the syrup compositions of the disclosure are homogenous showing a complete dissolution of the rebaudiosides and a syrup, and no interface between the aqueous solution and the syrup.

One aspect of the disclosure provides an aqueous sweetener composition including:
about 20% to about 60% by weight of rebaudioside composition, wherein the rebaudioside composition comprises: rebaudioside A, rebaudioside D, and rebaudioside M, wherein the ratio of rebaudioside A to the sum of rebaudioside D and rebaudioside M is about 1:1 to about 3:1, and wherein the ratio of rebaudioside M to rebaudioside D is about 1:2.3 to about 2.3:1;
and water.

As noted above, the aqueous sweetener compositions of the disclosure comprise a rebaudioside composition. Generally, rebaudiosides are found in an extract or extracts of Stevia rebaudiana (Bertoni) plant. The steviol glycosides may also be obtained by other means, including but not limited to, chemical or enzymatic modification of certain steviol glycoside components to obtain other steviol glycoside components, or production by fermentation processes. These rebaudiosides can be up to 300 times sweeter than sucrose. For their high level of sweetness and/or low level of bitterness, the rebaudioside composition of the disclosure comprises rebaudioside A, rebaudioside D, and rebaudioside M.

The inventors have found that a specific combination of rebaudiosides, e.g., rebaudioside A, rebaudioside D, and rebaudioside M present in a particular ratio, results in products having improved appearance, taste, and shelf-life.

For example, in one embodiment, the ratio of rebaudioside A to the sum of rebaudioside D and rebaudioside M is about 1:1 to about 3:1. In certain embodiments, the ratio of rebaudioside A to the sum of rebaudioside D and rebaudioside M is about 1.1:1 to about 3:1, or about 1.25:1 to about 3:1, or about 1.5:1 to about 3:1, or about 1.75:1 to about 3:1, 1:1 to about 2:1, or about 1.25:1 to about 2:1, or about 1.5:1 to about 2:1, or about 1.75:1 to about 2:1, or about 1:1 to about 1.8:1, or about 1:1 to about 1.75:1, or about 1:1 to about 1.5:1, or about 1:1 to about 1.25:1.

For example, in another embodiment, the ratio of rebaudioside M to rebaudioside D is about 1:2.3 to about 2.3:1. In certain embodiments, the ratio of rebaudioside M to rebaudioside D is about 1:1.5 to about 2.3:1, or about 1:1.5 to about 1.5:1, or about 1:1.2 to about 1.2:1, or about 1:1.25 to about 1.25:1, or about 1.1:1 to about 1:1, or about 1.2:1 to about 1:1, or about 1.3:1 to about 1:1, or about 1.4:1 to about 1:1, or about 1.5:1 to about 1:1, or about 2:1 to about 1:1, or about 2.3:1 to about 1:1, or about 1:1 to about 2.3:1, or about 1:1 to about 2:1, or about 1:1 to about 1.5:1, or about 1:1 to about 1.4:1, or about 1:1 to about 1.3:1, or about 1:1 to about 1.2:1.

In some embodiments, the ratio of rebaudioside A to rebaudioside D to rebaudioside M is about 10:2:3. In some embodiments, the ratio of rebaudioside A to rebaudioside D to rebaudioside M is about 10:3:3. In some embodiments, the ratio of rebaudioside A to rebaudioside D to rebaudioside M is or about 10:2:4. In some embodiments, the ratio of rebaudioside A to rebaudioside D to rebaudioside M is about 10:3:4. In some embodiments, the ratio of rebaudioside A to rebaudioside D to rebaudioside M is about 10:4:4. In some embodiments, the ratio of rebaudioside A to rebaudioside D to rebaudioside M is about 10:4:5. In some embodiments, the ratio of rebaudioside A to rebaudioside D to rebaudioside M is about 10:4:3. In some embodiments, the ratio of rebaudioside A to rebaudioside D to rebaudioside M is about 10:3:7. In some embodiments, the ratio of rebaudioside A to rebaudioside D to rebaudioside M is about 10:7:3. In some embodiments, the ratio of rebaudioside A to rebaudioside D to rebaudioside M is about 10:1:2.3. In some embodiments, the ratio of rebaudioside A to rebaudioside D to rebaudioside M is about 10:2.3:1. In some embodiments, the ratio of rebaudioside A to rebaudioside D to rebaudioside M is about 10:2.4:3.

In certain embodiments, rebaudioside A is present in about 50% to about 75% by weight based on the total weight of rebaudioside A, rebaudioside D, and rebaudioside M. For example, rebaudioside A is present in about 50 wt % to about 70 wt %, or 50 wt % to about 65 wt %, or about 50 wt % to about 63 wt %, or about 50 wt % to about 60 wt %, or about 50 wt % to about 57 wt %, or about 50 wt % to about 55 wt %, or 52 wt % to about 75 wt %, or 52 wt % to about 70 wt %, or 52 wt % to about 65 wt %, or about 52 wt % to about 63 wt %, or about 52 wt % to about 60 wt %, or about 52 wt % to about 57 wt %, or about 52 wt % to about 55 wt %, or about 55 wt % to about 75 wt %, or about 55 wt % to about 70 wt %, or about 55 wt % to about 67 wt %, or about 55 wt % to about 65 wt %, or about 55 wt % to about 63 wt %, or about 55 wt % to about 60 wt %, or about 55 wt % to about 57 wt %, or about 60 wt % to about 75 wt %, or about 60 wt % to about 70 wt %, or about 60 wt % to about 67 wt %, or about 60 wt % to about 65 wt %, or about 60 wt % to about 63 wt %, or about 63 wt % to about 67 wt %, or about 54 wt % to about 57 wt %, based on the total weight of rebaudioside A, rebaudioside D, and rebaudioside M.

In certain embodiments, rebaudioside D is present in about 7.5% to about 35% by weight based on the total weight of rebaudioside A, rebaudioside D, and rebaudioside M. For example, rebaudioside D is present in about 7.5 wt % to about 30 wt %, or about 7.5 wt % to about 25 wt %, or about 7.5 wt % to about 20 wt %, or about 7.5 wt % to about 18 wt %, or about 10 wt % to about 35 wt %, or about 10 wt % to about 30 wt %, or about 10 wt % to about 25 wt %, or about 10 wt % to about 20 wt %, or about 10 wt % to about 18 wt %, or about 10 wt % to about 15 wt %, or about 15 wt % to about 35 wt %, or about 15 wt % to about 30 wt %, or about 15 wt % to about 25 wt %, or about 15 wt % to about 20 wt %, or about 15 wt % to about 18 wt %, or about 18 wt % to about 35 wt %, or about 18 wt % to about 30 wt %, or about 18 wt % to about 25 wt %, or about 18 wt % to about 20 wt %, based on the total weight of rebaudioside A, rebaudioside D, and rebaudioside M.

In certain embodiments, rebaudioside M is present in about 7.5% to about 35% by weight based on the total weight of rebaudioside A, rebaudioside D, and rebaudioside M. For example, rebaudioside M is present in about 7.5 wt % to about 30 wt %, or about 7.5 wt % to about 28 wt %, or about 7.5 wt % to about 25 wt %, or about 7.5 wt % to about 20 wt %, or about 7.5 wt % to about 15 wt %, or about 10 wt % to about 35 wt %, or about 10 wt % to about 30 wt %, or about 10 wt % to about 28 wt %, or about 10 wt % to about 25 wt %, or about 10 wt % to about 20 wt %, or about 10 wt % to about 15 wt %, or about 20 wt % to about 35 wt %, or about 20 wt % to about 30 wt %, or about 20 wt % to about 28 wt %, or about 20 wt % to about 25 wt %, or about 22 wt % to about 35 wt %, or about 22 wt % to about 30 wt %, or about 22 wt % to about 28 wt %, or about 22 wt % to about 25 wt %, or about 25 wt % to about 35 wt %, or about 25 wt % to about 30 wt %, or about 25 wt % to about 28 wt %, or about 30 wt % to about 35 wt %, based on the total weight of rebaudioside A, rebaudioside D, and rebaudioside M.

The rebaudioside composition of the disclosure may also include other rebaudiosides, such as rebaudioside B, rebaudioside C, rebaudioside E, rebaudioside F, rebaudioside N, and rebaudioside O. In certain embodiments, the rebaudioside composition of the disclosure may also comprise other steviol glycosides, such as but not limited to, stevioside, dulcoside A, dulcoside B, and mixtures thereof.

While additional components can be present in the rebaudioside composition as described above, in certain desirable embodiments, the chief constituents are rebaudioside A, rebaudioside D, and rebaudioside M. Accordingly, in certain embodiments as otherwise described herein, the total amount of rebaudioside A, rebaudioside D, and rebaudioside M in the rebaudioside composition is at least about 75 wt %, or at least about 80 wt %, or at least about 85 wt %, or at least about 90 wt %, or at least about 95 wt %, or at least about 98 wt %, or at least about 99 wt % of the rebaudioside composition.

As noted above, the aqueous sweetener compositions of the disclosure comprise about 20 wt % to about 60 wt % of the rebaudioside composition. For example, in certain embodiments, the rebaudioside composition is present in the about of about 25 wt % to about 60 wt %, or about 30 wt % to about 60 wt %, or 35 wt % to about 60 wt %, or about 40 wt % to about 60 wt %, or about 45 wt % to about 60 wt %, or about 50 wt % to about 60 wt %, or about 55 wt % to about 60 wt %, or about 25 wt % to about 50 wt %, or about 35 wt % to about 50 wt %, or about 40 wt % to about 50 wt %, or about 45 wt % to about 50 wt %, or about 30 wt % to about 45 wt %, or about 30 wt % to about 40 wt %, or about 30 wt % to about 35 wt %, or about 35 wt % to about 45 wt %, or about 38 wt % to about 42 wt %, or about 39 wt % to about 41 wt %, or about 40 wt % based on the total weight of aqueous sweetener composition.

The aqueous sweetener composition of the disclosure have sweetness equivalent to about 60 gram to about 180 grams of sucrose per 1 gram of the aqueous sweetener composition.

The aqueous sweetener compositions of the disclosure are clear and/or stable for an extended period of time. More specifically, the aqueous sweetener compositions remain clear for extended periods of time (e.g., more than 30 days, more than 60 days, or even more than 90 days) after the composition has been prepared.

In certain embodiments, the clarity and stability of the disclosed compositions is achieved without the addition of stabilizers, e.g., antimicrobial agents, antioxidants, or solvents, such as ethanol or propylene glycol. As a consequence, the compositions disclosed herein are preferably free of such materials.

Thus, in one embodiment, the aqueous sweetener composition is substantially free of other additives. As used herein the term “substantially free of,” with respect to a particular ingredients, refers to the particular ingredient being present in a concentration less than is necessary for the ingredient to be effective to provide the benefit or property for which it otherwise would be used, for example, about 0.5 wt % or less, or about 0.1 wt % or less, or about 0.05 wt % or less (based on the total weight of the sweetener composition).

Another aspect of the disclosure provides syrup compositions. Such compositions include about 2-10% by weight of the aqueous sweetener composition of the disclosure as described herein, and about 90-98% by weight of one or more syrups.

As used herein, the term “syrup” means a solution, preferably a viscous solution, having from about 60% to 85% by weight, of carbohydrate solids and the balance primarily water, and having viscosity higher than that of water at 20° C. (i.e., higher than 1 mPa·s at 20° C.). In certain embodiments, the syrup as described herein is a solution having viscosity of at least 50 mPa·s at 20° C. The carbohydrate solids that make up the syrup as disclosed herein may be carbohydrate solids naturally present in the syrup, for example such as glucose and fructose present in honey. The carbohydrate solids that make up the syrup as disclosed herein may also be externally added, such as glucose and fructose present in invert sugar syrup. The carbohydrate solids that make up the syrup as disclosed herein may also comprise a combination of carbohydrate solids naturally present in the syrup and externally added carbohydrate solids. Likewise, the balance of water that makes up the syrup as disclosed herein may be naturally present in the syrup, such as water present in honey, or externally added, such as the water present in diluted honey.

The following are non-limiting examples of solutions that can serve as the syrup as disclosed herein: (i) agave syrup having about 75% naturally present carbohydrate solids and about 25% naturally present water; (ii) honey having about 82% naturally present carbohydrate solids and about 18% naturally present water; (iii) diluted honey having about 75% naturally present carbohydrate solids, about 16.5% naturally present water, and about 8.5% externally added water; and (iv) sweetened honey having about 70% naturally present carbohydrate solids, about 15.4% naturally present water, about 5% externally added fructose, and about 9.6% externally added water.

Suitable syrups for use herein are made up primarily of a mixture of water and glucose, fructose, fructo oligosaccharide, galacto oligosaccharide, inulin, and various other monosaccharides, oligosaccharides, polysaccharides, and/or oligoglucoses. Common examples of compositions which could function as the syrup component include invert sugar syrup, evaporated cane juice syrups (liquid cane syrups), corn syrup (with varying ratios of glucose to fructose), and natural syrups such as fruit syrups, tree syrups, bee syrups, tuber syrups, grass syrups, and mixtures thereof. An invert sugar syrup refers to glucose-fructose based syrup that results from the hydrolysis of sucrose into glucose and fructose. The syrups may include levels of solids such as particles of fruit.

In one embodiment, the syrup of the disclosure is selected from fruit syrups, tree syrups, bee syrups, tuber syrups, grass syrups, and mixtures thereof. In another embodiment, the syrup is selected from the group consisting of agave syrup, invert sugar syrup, sugarcane syrup, honey, maple syrup, almond syrup, banana syrup, blueberry syrup, cherry syrup, coconut syrup, hazelnut syrup, kiwi syrup, lemon syrup, mango syrup, orange syrup, peach syrup, strawberry syrup, vanilla syrup, raspberry syrup, apple syrup, blackberry syrup, pineapple syrup, molasses, and mixtures thereof. In another embodiment, the syrup is agave syrup, invert sugar syrup, sugarcane syrup, honey, coconut syrup, maple syrup, and mixtures thereof. In some embodiments, the syrup is agave syrup. In some embodiments, the syrup is honey.

In one embodiment of the syrup composition of the disclosure, the one or more syrups is present in amount of about 90 to about 98 wt % based on the total weight of the composition; for example, e.g., about 90 to about 97 wt %; or about 90 to about 95 wt %; or about 90 to about 93 wt %; or about 93 to about 98 wt %; or about 93 to about 97 wt %; or about 93 to about 95 wt %; or about 95 to about 98 wt %; or about 95 to about 97 wt %.

In one embodiment of the disclosure, the syrup comprises a combination of one or more natural syrups and one or more added carbohydrates. Suitable examples of added carbohydrates include, but are not limited to, monosaccharides (e.g., glucose, fructose, allulose, etc.), disaccharides (e.g.; sucrose, maltose, etc.), and sugar alcohols (e.g., erythritol, xylitol, sorbitol, maltitol, mannitol, isomalt, and mixtures thereof). In one embodiment of the sweetener composition of the disclosure, the syrup including the combination of one or more natural syrups and one or more added carbohydrates is present in amount of about 90 to about 98 wt % based on the total weight of the composition as described herein.

The syrup compositions of the disclosure have sweetness equivalent to about 2 gram to about 19 grams of sucrose, or about 2 gram to about 18 grams of sucrose, or about 2 gram to about 17 grams of sucrose, per every 1 gram of the syrup composition.

The syrup compositions of the disclosure are clear and/or stable for an extended period of time. More specifically, the syrup compositions remain clear for extended periods of time (e.g., more than 30 days, more than 60 days, or even more than 90 days) after the composition has been prepared.

In certain embodiments, the clarity and stability of the disclosed syrup compositions is achieved without the addition of stabilizers, e.g., antimicrobial agents, antioxidants, or solvents, such as ethanol or propylene glycol. As a consequence, the syrup compositions disclosed herein are preferably free of such materials. Thus, in one embodiment, the syrup composition is substantially free of other additives.

The disclosure also provides methods for preparing the syrup compositions of the disclosure. For example, in one embodiment, the disclosure provides a method of making a syrup composition of the disclosure, the method including
(a) providing an aqueous sweetener composition of the disclosure having a temperature of about 50° C. to about 95° C., and
(b) adding the aqueous sweetener composition to a syrup as disclosed herein to produce the desired syrup composition.

The aqueous sweetener composition is added at the room temperature or elevated temperature to the syrup and the resulting mixture blended until homogenous.

The methods of the disclosure may be performed wherein adding in (b) is a gradual addition with continuous stirring. Such stirring may be sufficient to obtain a homogeneous solution of the syrup composition. For example, the stirring speed and duration may be adjusted to provide a homogeneous solution of the syrup composition.

### Definitions

The following terms and expressions used have the indicated meanings.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an,” and “the” include plural referents unless the context clearly dictates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e., denoting somewhat more or somewhat less than the stated value or range, to within a range of ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value; or ±0.5% of the stated value; or ±0.1% of the stated value.

All percentages, ratios and proportions herein are by weight, unless otherwise specified. A weight percent (weight %, also as wt %) of a component, unless specifically stated to the contrary, is based on the total weight of the composition in which the component is included (e.g., on the total amount of the compositions).

### EXAMPLES

The methods of the disclosure are illustrated further by the following examples, which are not to be construed as limiting the disclosure in scope or spirit to the specific procedures and in them.

### Examples 1-18: Stability Studies

Rebaudioside A stevia leaf extract (“Reb-A”), rebaudioside D stevia leaf extract (“Delta” or “Zeta-M”), and rebaudioside M stevia leaf extract (“Reb-M”) were obtained from PureCircle (Kuala Lumpur, Malaysia) and used in this study. The commercially available extracts may contain one or more different glycosides. As a result, the glycoside ingredient breakdown of each commercially available extract is provided in Table 1.

TABLE 1

| | Glycoside ingredient breakdown (wt %) | | | | |
|---|---|---|---|---|---|
| | rebaudioside | rebaudioside | rebaudioside | rebaudioside | |
| | A | D | M | B | other |
| Reb-A¹ | 99 | 0 | 0 | 0 | 1 |
| Delta¹ | 38.2 | 56.8 | 0 | 0 | 5 |
| Zeta-M¹ | 1.4 | 71 | 22.7 | 0 | 4.9 |
| Reb-M¹ | 1.3 | 6.9 | 79.6 | 7.2 | 5 |

¹obtained from PureCircle (Kuala Lumpur, Malaysia)

Specifically, 40 wt % aqueous formulations of stevia leaf extracts were prepared by dissolving the solutes under heat (e.g., at a temperature of about 90 to 110° C.) and stirring until completely dissolved, then filtered and bottled. Solutions were analyzed by visual inspection to determine stevia precipitation. The visual inspection is generally performed in natural light. If necessary, however, a light source may be used to additionally illuminate the solution and assist in determination of precipitation.

Results with Composition of Reb-A, Delta, and Reb-M

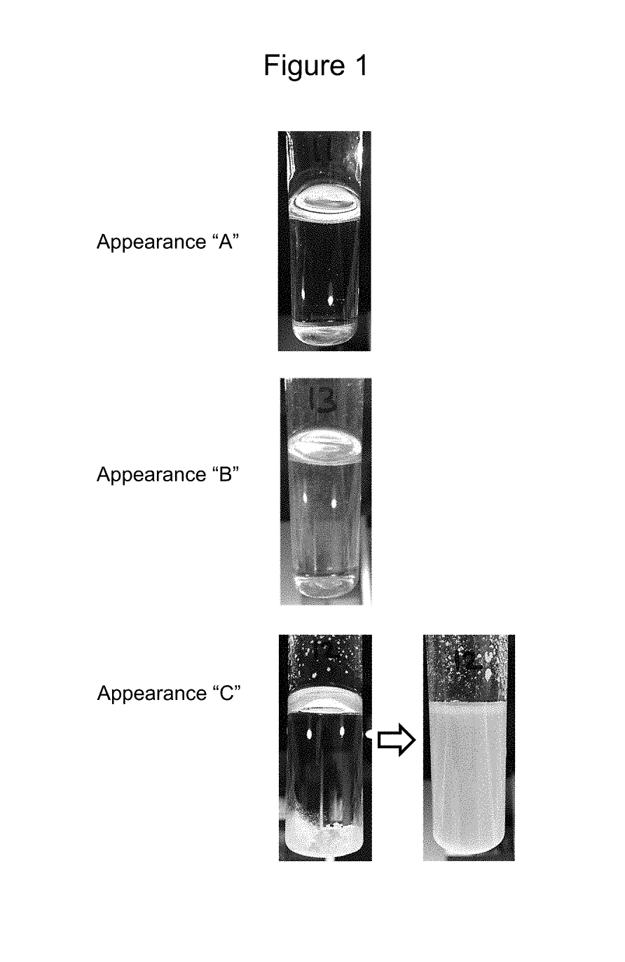

The relative final ratios of each rebaudioside in the aqueous composition prepared by mixing Reb-A, Delta, and Reb-M as described herein are as provided in Table 2. Results labeled “A” indicate no noticeable instability (e.g., by a consumer); results labeled “B” indicate some noticeable instability upon very close inspection; and results labeled as “C” indicate that precipitate formed. The appearance of the samples labeled as “A,” “B,” and “C” is also provided in FIG. 1.

TABLE 2

| | final ratio of | |
|---|---|---|
| Example | rebaudioside | Week |

| No. | A:D:M¹ | 1 | 3 | 6 | 9 | 14 |
|---|---|---|---|---|---|---|
| 1 | 10:2:3 | A | A | A | A | A |
| 2 | 10:3:3 | A | A | A | A | A |
| 3 | 10:4:3 | A | A | A | B | C |
| 4 | 10:2:4 | A | A | A | A | C |
| 5 | 10:3:4 | A | A | A | A | A |
| 6 | 10:4:4 | A | A | A | B | B |
| 7 | 10:2:5 | A | C | C | C | C |
| 8 | 10:3:5 | A | B | C | C | C |
| 9 | 10:4:5 | A | A | A | C | C |

¹relative ratios obtained by mixing appropriate amounts of “Reb-A,” “Delta,” and “Reb-M”

Results with Composition of Reb-A, Zeta-M, and Reb-M

The relative final ratios of each rebaudioside in the aqueous composition prepared by mixing Reb-A, Zeta-M, and Reb-M as described herein are as provided in Table 3. Results labeled “A” indicate no noticeable instability (e.g., by a consumer); results labeled “B” indicate some noticeable instability upon very close inspection; and results labeled as “C” indicate that precipitate formed. The appearance of the samples labeled as “A,” “B,” and “C” is also provided in FIG. 1.

TABLE 3

| | | |
|---|---|---|
| | final ratio of | |
| Example | rebaudioside | Week |

| No. | A:D:M¹ | 1 | 3 | 6 | 9 | 14 |
|---|---|---|---|---|---|---|
| 10 | 10:2:3 | A | A | A | A | A |
| 11 | 10:3:3 | A | B | B | B | B |
| 12 | 10:4:3 | A | B | C | C | C |
| 13 | 10:2:4 | A | A | A | A | A |
| 14 | 10:3:4 | A | A | A | A | A |
| 15 | 10:4:4 | A | B | B | C | C |
| 16 | 10:2:5 | A | B | C | C | C |
| 17 | 10:3:5 | A | B | C | C | C |
| 18 | 10:4:5 | A | B | B | C | C |

¹relative ratios obtained by mixing appropriate amounts of “Reb-A,” “Zeta-M,” and “Reb-M”

Without being bound to a particular theory, it is believed that the differences in stability of the samples containing Delta as a source of rebaudioside D compared to Zeta-M as a source of rebaudioside D are due to minor compositional differences of other components (e.g., stevioside, dulcoside, other rebaudiosides, steviolbioside, contaminants, etc.) present in each respective set of materials.

It is understood that the examples and embodiments described herein are for illustrative purposes only and that various modifications or changes in light thereof will be suggested to persons skilled in the art and are to be incorporated within the spirit and purview of this application and scope of the appended claims. All publications, patents, and patent applications cited herein are hereby incorporated herein by reference for all purposes.

We claim:

1. An aqueous sweetener composition comprising:
about 20% to about 60% by weight of rebaudioside composition, wherein the rebaudioside composition comprises: rebaudioside A, rebaudioside D, and rebaudioside M, wherein the ratio of rebaudioside A to the sum of rebaudioside D and rebaudioside M is about 1:1 to about 3:1, and wherein the ratio of rebaudioside M to rebaudioside D is about 1:2.3 to about 2.3:1;
and water.

2. The aqueous sweetener composition of claim 1, wherein the ratio of rebaudioside A to the sum of rebaudioside D and rebaudioside M is about 1:1 to about 2:1.

3. The aqueous sweetener composition of claim 1, wherein the ratio of rebaudioside M to rebaudioside D is about 1:1.5 to about 2.3:1.

4. The aqueous sweetener composition of claim 1, wherein rebaudioside A is present in about 50% to about 75% by weight based on the total weight of rebaudioside A, rebaudioside D, and rebaudioside M.

5. The aqueous sweetener composition of claim 1, wherein rebaudioside D is present in about 7.5% to about 35% by weight based on the total weight of rebaudioside A, rebaudioside D, and rebaudioside M.

6. The aqueous sweetener composition of claim 1, wherein rebaudioside M is present in about 7.5% to about 35% by weight based on the total weight of rebaudioside A, rebaudioside D, and rebaudioside M.

7. The aqueous sweetener composition of claim 1, wherein the ratio of rebaudioside A to rebaudioside D to rebaudioside M is about 10:2.4:3.

8. The aqueous sweetener composition of claim 1, wherein the total amount of rebaudioside A, rebaudioside D, and rebaudioside M is at least about 98 wt % of the rebaudioside composition.

9. The aqueous sweetener composition of claim 1, wherein the rebaudioside composition is present in the range of about 40 wt % to about 60 wt based on the total weight of aqueous sweetener composition.

10. The aqueous sweetener composition of claim 1, wherein 1 gram of the sweetener composition has sweetness equivalent to about 60 grams to about 180 grams of sucrose.

11. A syrup composition comprising:
(i) about 2-10% by weight of aqueous sweetener composition, wherein the aqueous sweetener composition comprises:
about 20% to about 60% by weight of rebaudioside composition, wherein the rebaudioside composition comprises: rebaudioside A, rebaudioside D, and rebaudioside M, wherein the ratio of rebaudioside A to the sum of rebaudioside D and rebaudioside M is about 1:1 to about 3:1, and wherein the ratio of rebaudioside M to rebaudioside D is about 1:2.3 to about 2.3:1;
and water; and
(ii) about 90-98% by weight of one or more syrups.

12. The syrup composition of claim 11, wherein the syrup is selected from the group consisting of agave syrup, inverted sugar syrup, sugarcane syrup, honey, maple syrup, almond syrup, banana syrup, blueberry syrup, cherry syrup, coconut syrup, hazelnut syrup, kiwi syrup, lemon syrup, mango syrup, orange syrup, peach syrup, strawberry syrup, vanilla syrup, raspberry syrup, apple syrup, blackberry syrup, pineapple syrup, molasses, and mixtures thereof.

13. The syrup composition of claim 11, wherein the syrup is agave syrup, inverted sugar syrup, sugarcane syrup, honey, coconut syrup, maple syrup, and mixtures thereof.

14. The syrup composition of claim 11, wherein the syrup is agave syrup.

15. The syrup composition of claim 11, wherein the syrup is honey.

16. The syrup composition of claim 11, wherein syrup is present in amount of about 93 to about 98 wt %, based on the total weight of the syrup composition.

17. The syrup composition of any of claim 11 substantially free of other additives.

18. The syrup composition of any of claim 11 substantially homogeneous and clear.

19. The syrup composition of any of claim 11, wherein 1 gram of the syrup composition has sweetness equivalent to about 2 gram to about 19 grams of sucrose.

20. A method of making a syrup composition of claim 11, the method comprising:
providing an aqueous sweetener composition having a temperature of about 50° C. to about 95° C., wherein the aqueous sweetener composition comprises:
about 20% to about 60% by weight of rebaudioside composition, wherein the rebaudioside composition comprises: rebaudioside A, rebaudioside D, and rebaudioside M, wherein the ratio of rebaudioside A to the sum of rebaudioside D and rebaudioside M is about 1:1 to about 3:1, and wherein the ratio of rebaudioside M to rebaudioside D is about 1:2.3 to about 2.3:1;
and water; and
adding the aqueous sweetener composition to a syrup.
